(19) United States
(12) Patent Application Publication
(10) Pub. No.: US 2004/0035288 A1
(43) Pub. Date: Feb. 26, 2004

(54) Cushioned hydraulic cylinder

(75) Inventor: Steven C. Hawthorne, Hays, KS (US)

Correspondence Address: EDWARD L. BROWN, JR., Suite 1100, 125 North Market, Wichita, KS, 67202, US

(73) Assignee: CROSS MANUFACTURING, INC.

(21) Appl. No.: 10/228,000

(22) Filed: Aug. 26, 2002

(51) Int. Cl. F15B 15/22

(52) U.S. Cl. 91/394

(57) ABSTRACT

A cushioned hydraulic cylinder which includes a check valve in the cushioning path to allow fast opposite direction movement. The check valve is in the form of a cast iron piston ring located within a groove in the piston which blocks unrestricted flow across the piston when the piston ring is seated against one side face of the groove and opens unrestricted flow when the piston ring abuts the opposite side face of the groove when the piston is moving in the opposite direction.

The present invention is generally directed to hydraulic cylinders and more specifically to slowing or cushioning the stroke as the piston approaches the end of the cylinder in either its fully retracted or fully extended position. Cushioned cylinders are desired in many different applications. Wherever there is a heavy inertia load on the cylinder at the end of the cylinder travel, cushioning is required. Examples of such use would be a cylinder swinging a boom on a back hoe which must be slowed substantially before hitting the mechanical stops at the end of the swing which would otherwise cause either mechanical or hydraulic damage to the system.

### BACKGROUND OF THE INVENTION

The concept of cushioning a hydraulic cylinder has been around since the mid-1800's, as evidenced by the patent to Barrett, U.S. Pat. No. 19,119. There are at least two categories of cushioning designs for the end stroke, the first being the two-hole type and second being a cushioned sleeve cooperating with a recess in the piston at the stroke end which forces flow to pass a particular throttle or orifice. In the first two-hole category, we have the patents to Barrett, above mentioned, the patent to Thorschmidt, U.S. Pat. No. 865,266, and the patent to Kelley, U.S. Pat. No. 4,393,751. With two-hole cushioning, a first unrestricted hole is located longitudinally in the cylinder approximate the end of its stroke. A second hole containing a throttling orifice is located in the cylinder wall between the first hole and the end of the cylinder. As the piston in the cylinder approaches the end of the stroke, the first unrestricted passage is blocked, thereby slowing the piston's movement due to the restricted flow through the second throttling orifice until it reaches the end of the stroke.

The above-mentioned patent to Kelley very clearly discloses two-hole cushioning when the holes are located in the cylinders while the present invention locates the two holes in the piston. In U.S. Pat. No. 19,119 to Barrett and U.S. Pat. No. 865,266 to Thorschmidt both teach two-hole cushioning designs with holes in the cylinder wall rather than the piston. The idea of a check valve in the cushioning path to permit fast opposite direction piston movement is taught by Kelley.

The second category of cushioning designs, referred to as cushion sleeves, includes U.S. Pat. No. 3,999,463 to Greenwood, U.S. Pat. No. 2,935,047 to Ortman etal, and U.S. Pat. No. 5,307,729 to Hedlund. In all of these cushion sleeve designs a sleeve on the outside end of the piston cooperates with a reduced diameter end chamber blocking the exhaust flow which normally flows unrestricted through the exhaust part of the cylinder, thereby limiting the flow to a throttling orifice which bypasses the normal flow path exiting the cylinder. All of the cushion sleeved patents above-mentioned are quite complex and include numerous parts as compared with the very simple design of the present invention.

The above-mentioned patent to Ortman et al includes the idea of a check valve in the cushioning path to permit fast opposite direction movement with a resilient ring 88 which blocks an unrestricted flow path in one direction while opening it in the opposite direction.

The above-mentioned patent to Hedlund teaches a check valve in the cushioning path in the form of a lip seal 13.

In the above-mentioned patent to Greenwood, the check valve function for rapid opposite direction piston movement is achieved with a spring bias sliding sleeve 78 which is quite complex as compared with the present invention.

### SUMMARY OF THE INVENTION

The present invention provides a check valve in the cushioning path to allow fast opposite direction movement through the valving function of the cast iron ring located within a groove in the piston. Piston rings exist in most hydraulic cylinders today to function as a seal and/or a bearing between the piston and the cylinder wall in like manner as do piston rings in internal combustion engines. The piston rings include outward spring tension against the cylinder wall to provide a circumferential partial seal. The groove in the piston which carries the ring is slightly wider than the wear ring whereby pressure differentials across the ring will cause the ring to slide in the groove from one side face to the other. In the present invention the ring forms the secondary function of acting as a check valve in the cushioning path which blocks unrestricted flow when the ring is seated against one side face of the groove and opens unrestricted flow when the ring abuts the opposite side face of the groove.

It is therefore the principal object of the present invention to provide a simplified cushioned cylinder in one direction of movement with unrestricted movement in the opposite direction.

Another object of the present invention is to provide a hydraulic cylinder which utilizes a piston ring as a check valve.

A further object of the present invention is to provide a cushioned two-holed cylinder construction wherein the holes are in the piston rather than the cylinder wall.

Another object is to provide a metal seal which can pass over a port in the cylinder wall without shearing the seal.

Other objects of the present invention will occur to those skilled in the art as the description proceeds and will be seen from the detailed description of the preferred embodiment and the illustrations thereof, and that modification is capable of being made without in any way departing from the spirit of the invention.

### BRIEF DESCRIPTION OF THE DRAWINGS

FIG. 1 is a partial longitudinal sectional view of the cylinder of the present invention;

FIG. 2 is a similar sectional view to FIG. 1 with the wear ring fully blocking the unrestricted flow path; and

FIG. 3 is a similar view to FIG. 2 with the wear ring in the unobstructed position.

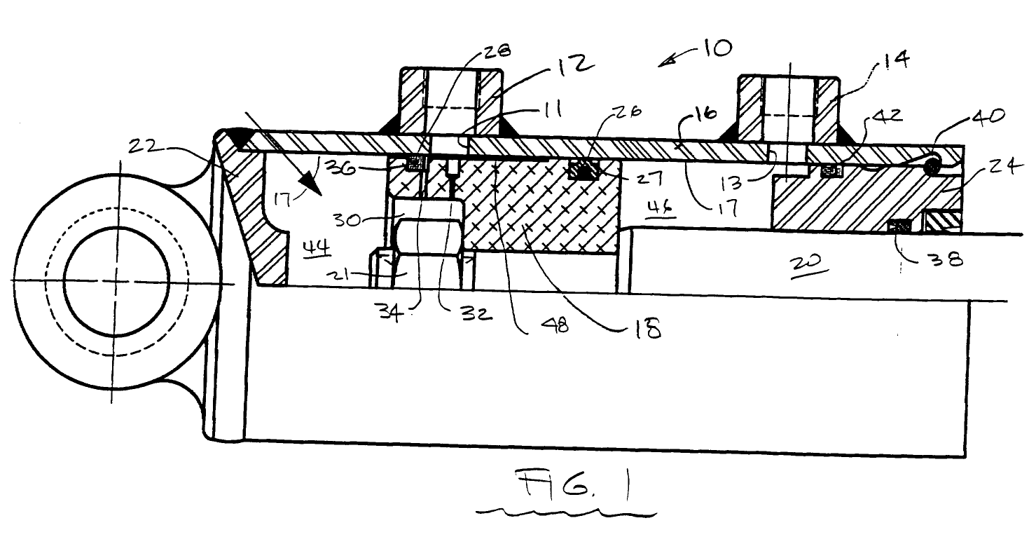

### DETAILED DESCRIPTION OF THE PREFERRED EMBODIMENT

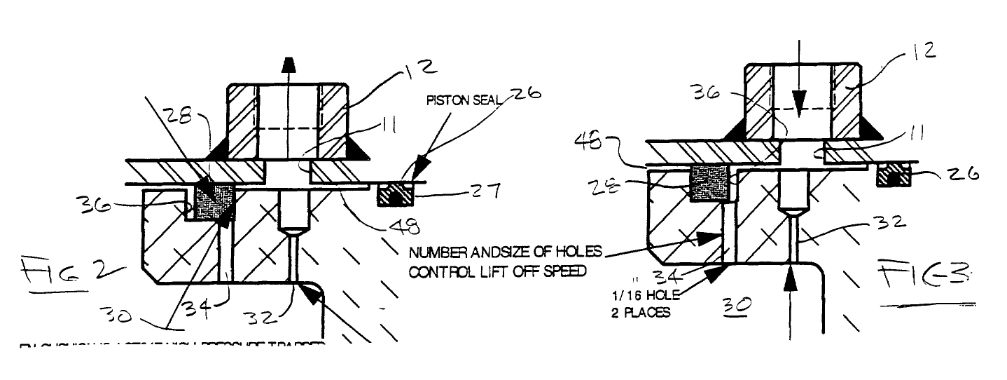

The hydraulic cylinder of the present invention, as generally described by reference numeral 10, includes a barrel 16 with a head end 22 welded in place and a rod end 24 held in place by a removable snap ring 40. Located within the cylinder 10 is a piston 18 connected to a rod 20 by conventional means. Cylinder rod end 24 includes a groove containing a seal 42 between the barrel 16 and rod end 24 while seal 38 seals any flow between rod 20 and cylinder rod end 24. Piston 18 includes a concentric cavity 30 for receipt of the threaded end of piston rod 20 which is held in place by threaded nut 21. Located at the right end of piston 18 is an elastomeric seal 26 located in a groove 27. At the opposite end of piston 18 is a groove 36 containing a cast iron piston ring 28 which provides a seal for the piston against the inside surface 17 of the cylinder barrel 16. In viewing FIGS. 2 and 3, it can be seen that the groove 36 is wider than ring 28, allowing ring 28 to move longitudinally in reaction to a pressure drop across the ring from one side face of the groove to the other. A drilled unrestricted passage 34 lies adjacent the right side face of groove 36, as shown in FIGS. 2 and 3. The flow in passage 34 is unrestricting in FIG. 3 from passage 34 through port 12. Piston 18 includes two or more additional passages 34 in the piston not shown which also intersect the right side face groove 36. When ring 28 is in its FIG. 2 position all flow is blocked in unrestricted passage 34. Ring 28, also referred to as a piston ring, is a typical split ring design having overlapping ends which substantially block any flow across the ring 28. Also drilled in piston 18 is a restricted orifice 32 which throttles the movement of the piston as it approaches the head end 22 of the cylinder.

The cylinder illustrated is a double acting cylinder of a welded design having two exterior ports 12 and 14 welded to the barrel 16 and a pair of port holes 11 and 13 in the cylinder barrel 16. Cylinder 10 includes cushioning only at the head end 22. However, it could have cushioning at both ends if desired.

Operation

When the piston rod and piston 18 are moving from right to left, as seen in the drawing, high pressure is entering port 14 into the rod end chamber 46 of the cylinder while the oil in head end chamber 44 is near atmospheric and flowing to reservoir. As ring 28 passes over port hole 11, pressure in head end chamber 44 rises substantially since unrestricted flow is blocked and the only flow exiting head end chamber 44 is passing through orifice 32and ring 28 is blocking the flow in unrestricted passage 34, as shown in FIG. 2.

With piston 18 fully retracted against the cylinder head end 22, which is not shown in the drawings, and it is desired to extend hydraulic cylinder 10, high pressure is applied at port 12 with very little flow passing through orifice throttle 32, the high pressure on the right side of ring 28 forces ring 28 to the opposite side of groove 36, thus opening unrestricted passage 34 and thereby allowing the piston to move at an unrestricted rate. The undercut area 48 on the left end of the piston allows unrestricted flow to pass via passage 34 even before ring 28 passes port hole 11. Split ring 28, due to it outward spring tension against the cylinder wall, attempts to hold the ring from movement. However, as the piston 18 moves either right or left, the ring will engage the side face of the piston groove opposite to that of the direction of movement of the piston. Therefore, as the piston is moving to the left, approaching the cushioning end of the stroke, ring 28 will be bearing against the right side face of groove 36, as shown in FIG. 2, thus blocking any unrestricted flow through passage 34. Ring's movement from one side face to the other blocking the flow in passage 34 in one position and unrestricting the flow in the other position has the basic function of a check valve, thereby providing throttling of the piston's end stroke in one direction and unobstructed flow in the other. Throttling orifice 32 can be of any size for whatever speed is desired. The shape of piston cavity 30 and the orientations of orifice 32 and passage 34 can of course be repositioned and still achieve essentially the same results. The number of piston rings and receiving grooves could also be changed while maintaining the same fuinction.

Piston rings can be other metals than cast iron or other rigid materials.

It is understood that the invention is not to be limited to the preceding description but may be modified within the scope of the impending claims.

What is claimed is:

1. A cushioned hydraulic cylinder comprising:
a cylinder wall having at least one port in the cylinder wall;
a piston located within the cylinder connected to a piston rod;
a circumferential groove in the piston having opposing side faces;
a split spring tensioned ring positioned in said groove, sealing flow between the piston and the cylinder wall, the groove having a width wider than said ring, permitting the ring to slide longitudinally in the groove;
an orifice passage in the piston connecting areas on opposite side of ring;
at least one unrestricted passage in the piston connecting areas on opposite sides of the ring, the unrestricted passage is blocked when the ring is against one side face of the groove and open when the ring is against the opposite side face of the groove, whereby there is a restricted flow across the piston as the piston approaches the end of its stroke in one direction and unrestricted flow across the piston when the piston is moving in the opposite direction.

2. A cushioned hydraulic cylinder, as set forth in claim 1, wherein the piston has a cavity in the cushioning end of the piston which is surrounded by the circumferential groove, the unrestricted passage is radially positioned in the piston joining the said cavity with one side face of the circumferential groove.

3. A cushioned hydraulic cylinder, as set forth in claim 1, wherein the piston has a cavity in the piston which is surrounded by the circumferential groove, the orifice passage is radially positioned in the piston and connects with said cavity, the unrestricted passage is radially positioned in the piston between oriface passage and the end of the piston and connects with said cavity.

4. A cushioned hydraulic cylinder comprising:
a cylinder wall having at least one port in the cylinder wall;
a piston located within the cylinder connected to a piston rod;
a circumferential groove in the piston having opposing side faces;
a split spring tensioned ring positioned in said groove, sealing flow between the piston and the cylinder wall, the groove having a width wider than said ring, permitting the ring to slide longitudinally in the groove;
an orifice passage in the piston connecting areas on opposite side of ring;
at least one unrestricted passage in the piston connecting areas on opposite sides of the wear ring, the unrestricted passage intersects said groove adjacent one side face whereby flow is blocked when the ring is against said side face and open when the ring is against the opposite side face.
